(19) United States
(12) Patent Application Publication
(10) Pub. No.: US 2009/0160359 A1
(43) Pub. Date: Jun. 25, 2009

(54) LIGHT EMITTING DIODE CONTROL CIRCUIT WITH CONSTANT-CURRENT CIRCUIT

(75) Inventors: Ming-Chung Lee, Tu-Cheng (TW); Shih-Tse Tseng, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/189,812

(22) Filed: Aug. 12, 2008

(30) Foreign Application Priority Data
Dec. 21, 2007 (CN) 200710203310.3

(51) Int. Cl. H05B 37/02

(52) U.S. Cl. 315/292

(57) ABSTRACT

A light emitting diode (LED) control circuit can control a liquid crystal display (LCD). The LED control circuit includes a switch and a constant-current circuit. Typically, the switch includes an input terminal connected to a power source via an LED to be controlled, a control terminal configured for receiving a control signal to turn on or turn off the switch, and an output terminal. The constant-current circuit includes a first transistor and a first resistor. A collector of the first transistor is connected to a control terminal of the switch. An output terminal of the switch and a base of the first transistor are both connected to an emitter of the first transistor via the first resistor. If the switch is turned on according to the control signal, then the power source is connected to provide a constant current for controlling the LED to emit light.

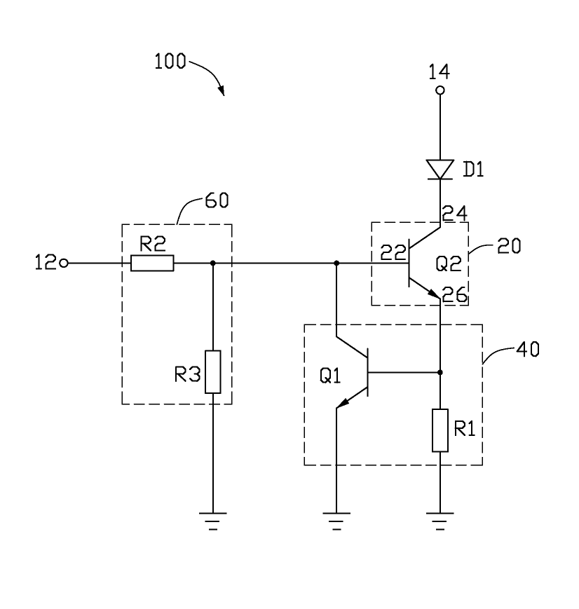

### BACKGROUND

1. Field of the Invention

Embodiments of the present disclosure relate to light emitting diodes, and more particularly to a control circuit for controlling a light emitting diode.

2. Description of Related Art

Liquid crystal displays (LCDs) are widely used in portable electronic devices such as digital cameras and mobile telephones, for example. These portable electronic devices are increasingly becoming smaller and thus require smaller electrical circuitry. A backlight unit of an LCD commonly utilizes light emitting diodes (LEDs) to control a luminous intensity of the LCD. The luminous intensity of the LCD requires a constant voltage control circuit to drive the LCD. Typically, a typical constant voltage control circuit includes a number of electrical components, such as resistors, capacitors, and noise filters, which increases a size of the constant voltage control circuit. Thus, the size of the voltage control circuit is a size limitation for small portable electronic devices.

Accordingly, it is desired to provide an LED control circuit which can overcome the above-mentioned problems.

### SUMMARY

In one aspect, a light emitting diode control circuit comprises a switch and a constant-current circuit. The switch comprises an input terminal connected to a power source via an LED, a control terminal configured for receiving a control signal to turn on or turn off the switch, and an output terminal. The switch controls the LED. The constant-current circuit comprises a first transistor and a first resistor. A collector of the first transistor is connected to the control terminal of the switch. The output terminal of the switch and a base of the first transistor are both connected to a first terminal of the first resistor. The emitter of the first transistor and a second terminal of the first resistor are both grounded.

Other advantages and novel features will become more apparent from the following detailed description of various embodiments when taken in conjunction with the accompanying drawings.

### BRIEF DESCRIPTION OF THE DRAWING

The drawing is a schematic of one embodiment of an LED control circuit configured to control an LED to emit light.

### DETAILED DESCRIPTION OF CERTAIN INVENTIVE EMBODIMENTS

The drawing is a schematic of one embodiment of an LED control circuit 100 configured to control an LED D1 to emit light. The LED control circuit 100 includes a switch 20, a constant-current circuit 40, and a voltage-dividing circuit 60.

The switch 20 includes a control terminal 22, an input terminal 24 and an output terminal 26. The constant-current circuit 40 includes a first transistor Q1 and a first resistor R1. The voltage-dividing circuit 60 includes a second resistor R2 and a third resistor R3.

The control terminal 22 is connected to a signal terminal 12 via the second resistor R2. The input terminal 24 is connected to a power supply terminal 14 via the LED D1. A cathode of the LED D1 is connected to the input terminal 24, and an anode of the LED D1 is connected to the power supply terminal 14. The output terminal 26 is grounded via the first resistor R1.

In one embodiment, the switch 20 includes a second transistor Q2. A base of the second transistor Q2 is the control terminal 22. A collector of the second transistor Q2 is the input terminal 24. An emitter of the second transistor Q2 is the output terminal 26. It may be understood that, depending on the embodiment, the transistor Q1 and the transistor Q2 may be replaced with other transistors, such as negative-channel metal-oxide semiconductor (NMOS) transistor, for example.

A collector of the first transistor Q1 and the base of the second transistor Q2 are both connected to the signal terminal 12 via the second resistor R2. The collector of the second transistor Q2 is connected to the power supply terminal 14 via the LED D1. The emitter of the second transistor Q2 and a base of the first transistor Q1 are both connected to a same first terminal of the first resistor R1. A second terminal of the first resistor R1 and the emitter of the first transistor Q1 are grounded.

The cathode of the LED D1 is connected to the collector of the second transistor Q2, and the anode of the LED D1 is connected to the power supply terminal 14.

A first terminal of the third resistor R3 is connected to the junction of the collector of the first transistor Q1 and the second resistor R2. A second terminal of the third resistor R3 is grounded.

The power supply terminal 14 provides a direct-current power supply having a voltage U1. In one embodiment, the signal terminal 12 may receive a control signal from one or more components of a portable electronic device. The control signal, in one embodiment, is a periodic impulse voltage signal with a constant frequency for controlling the input voltage at the power supply terminal 14. The power supply terminal 14, in one embodiment, may obtain power from a battery or any portable or non-portable direct-current power supply.

In operation, a periodic impulse voltage signal is applied to the base of the second transistor Q2, via the second resistor R2, resulting in the second transistor Q2 turning on. Because the second transistor Q2 is turned on, there is a voltage differential between the emitter of the second transistor Q2 and the ground terminal of the first resistor R1. The voltage differential, in one embodiment, may cause the first transistor Q1 to turn on. When the first transistor Q1 is in an “on” condition, a breakdown voltage between the base and the emitter of the first transistor Q1 is U_{be}. It may be appreciated that when the first transistor Q1 is in an “on” condition, a voltage across the first resistor R1 may be substantially equal to the value of the breakdown voltage U_{be}.

In one embodiment, the breakdown voltage U_{be} may be about 0.6 volts. However, it may be appreciated that a voltage of the breakdown voltage U_{be} may vary depending on the particular transistor used for the first transistor Q1 and the second transistor Q2. In one example, R1 may be about 22 ohms causing U_{be} to be about 0.557 volts. Thus, a current, I1, flowing through the first resistor R1, may be expressed as U_{be}/R1 or 25.3 milliamperes (mA).

In one embodiment, a current flowing through the base of the second transistor Q2 may be negligible, thus causing the current I1 flowing through the LED D1 to be substantially equal to the current flowing through the first resistor R1. Thus, the current I1 flowing through the LED D1 is substantially constant.

It is to be understood that when two periodic impulse voltage control signals have a same impulse time but with different periods, a period of the second transistor Q2 turning on is different from a period of the first transistor Q1 turning on. As a result of the different periods of the first and the second transistor, an average of the current flowing through the LED D1 is different. In one example, if a ratio (duty-cycle) of the time value of the second transistor Q2 turning on to turning off is 0.9, then a current flowing through the LED D1 is 24.8 mA. However, in another example, if the ratio is 0.7, then the current flowing through the LED D1 is 19.5 mA. Thus, a current flowing through the LED D1 can be regulated based on a control signal received by the signal terminal 120.

The LED control circuit 100 provides a constant current flowing through the LED D1 with the use of a simple, low cost circuit. Advantageously, the LED control circuit 100 may be positioned within an LCD where a control signal may be modulated to the LED control circuit 100 in order to control a luminous intensity of the LCD.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of arrangement of parts within the principles of the invention to the full extent indicated by the broad general meaning of the terms in which the appended claims are expressed.

What is claimed is:

1. A light emitting diode control circuit comprising:
a switch comprising an input terminal capable of being connected to a power source via a light emitting diode (LED), a control terminal configured for receiving a control signal to turn on or off the switch, and an output terminal, wherein the switch is configured to control the LED; and
a constant-current circuit comprising a first transistor and a first resistor, wherein the collector of the first transistor is connected to the control terminal of the switch, wherein the output terminal of the switch and a base of the first transistor are both connected to a first terminal of the first resistor, and wherein an emitter of the first transistor and a second terminal of the first resistor are grounded.

2. The light emitting diode control circuit of claim 1, wherein the switch further comprises a second transistor, wherein an emitter of the second transistor is connected to the base of the first transistor, wherein a base of the second transistor is connected to the collector of the first transistor for receiving the control signal, and wherein a collector of the second transistor is capable of being connected to the power source via the LED.

3. The light emitting diode control circuit of claim 1, further comprising a signal terminal and a voltage-dividing circuit, the voltage-dividing circuit having a second resistor, wherein the collector of the first transistor and the control terminal of the switch are both connected to the signal terminal via the second resistor for receiving the control signal.

4. The light emitting diode control circuit of claim 2, further comprising a signal terminal and a voltage-dividing circuit, the voltage-dividing circuit having a second resistor, wherein the collector of the first transistor and the base of the second transistor are both connected to the signal terminal via the second resistor for receiving the control signal.

5. The light emitting diode control circuit of claim 3, wherein the voltage-dividing circuit further comprises a third resistor, wherein a first terminal of the third resistor is connected a junction of the collector of the first transistor and the second resistor, and wherein a second terminal of the third resistor is grounded.

6. The light emitting diode control circuit of claim 1, further comprising a power supply terminal, wherein the input terminal of the switch is capable of being connected to the power supply terminal, via the LED, for receiving the power source.

7. The light emitting diode control circuit of claim 2, further comprising a power supply terminal, wherein the collector of the second transistor is capable of being connected to the power supply terminal, via the LED, for receiving the power source.

8. The light emitting diode control circuit of claim 7, wherein the collector of the second transistor is capable of being connected to a cathode of the LED, and wherein the power supply terminal is capable of being connected to an anode of the LED.

9. The light emitting diode control circuit of claim 1, wherein the control signal is a periodic impulse signal.
